(19) United States
(12) Patent Application Publication
(10) Pub. No.: US 2021/0012196 A1
(43) Pub. Date: Jan. 14, 2021

(54) PEER-TO-PEER TRAINING OF A MACHINE LEARNING MODEL

(71) Applicant: The Regents of the University of California, Oakland, CA (US)

(72) Inventors: Anusha Lalitha, San Diego, CA (US); Tara Javidi, San Diego, CA (US); Farinaz Koushanfar, San Diego, CA (US); Osman Cihan Kilinc, San Diego, CA (US)

(21) Appl. No.: 16/926,534

(22) Filed: Jul. 10, 2020

Related U.S. Application Data
(60) Provisional application No. 62/873,057, filed on Jul. 11, 2019.

(51) Int. Cl. G06N 3/08; G06N 3/04

(52) U.S. Cl. CPC G06N 3/08; G06N 3/0454; G06N 3/0472

(57) ABSTRACT

A method may include training, based on a first training data available at a first node in a network, a first local machine learning model. A first local belief of a parameter set of a global machine learning model may be updated based on the training of the first local machine learning model. A second local belief of the parameter set of the global machine learning model may be received from a second node in the network. The second local belief may have been updated based on the second node training a second local machine learning model. The second local machine learning model may be trained based on a second training data available at the second node. The first local belief may be updated based on the second local belief of the second node. Related systems and articles of manufacture, including computer program products, are also provided.

### RELATED APPLICATION

This application claims priority to U.S. Provisional Application No. 62/873,057 entitled “PEER-TO-PEER LEARNING ON GRAPHS” and filed on Jul. 11, 2019, the disclosure of which is incorporated herein by reference in its entirety.

### TECHNICAL FIELD

The subject matter described herein relates generally to machine learning and more specifically to peer-to-peer training of a machine learning model over a network of nodes.

### BACKGROUND

Machine learning models may be trained to perform a variety of cognitive tasks including, for example, object identification, natural language processing, information retrieval, and speech recognition. A deep learning model such as, for example, a neural network, may be trained to perform a classification task by at least assigning input samples to one or more categories. The deep learning model may be trained to perform the classification task based on training data that has been labeled in accordance with the known category membership of each sample included in the training data. Alternatively and/or additionally, the deep learning model may be trained to perform a regression task. The regression task may require the deep learning model to predict, based at least on variations in one or more independent variables, corresponding changes in one or more dependent variables.

### SUMMARY

Systems, methods, and articles of manufacture, including computer program products, are provided for peer-to-peer training of a machine learning model. In some example embodiments, there is provided a system that includes at least one processor and at least one memory. The at least one memory may include program code that provides operations when executed by the at least one processor. The operations may include: training, based at least on a first training data available at a first node in a network, a first local machine learning model; updating, based at least on the training of the first local machine learning model, a first local belief of a parameter set of a global machine learning model; receiving, from a second node in the network, a second local belief of the parameter set of the global machine learning model, the second local belief having been updated based at least on the second node training a second local machine learning model, and the second local machine learning model being trained based at least on a second training data available at the second node; and updating, based at least on the second local belief of the second node, the first local belief of the parameter set of the global machine learning model.

In some variations, one or more features disclosed herein including the following features can optionally be included in any feasible combination. The first local belief of the parameter set of the global machine learning model may be sent to the second node such that the second local belief of the second node is further updated based on the first local belief of the first node.

In some variations, a third local belief of the parameter set of the global machine learning model may be received from a third node in the network. The third local belief may have been updated based at least on the third node training a third local machine learning model. The third local machine learning model may be trained based at least on a third training data available at the third node. The first local belief of the parameter set of the global machine learning model may be updated based at least on an aggregate of the second local belief and the third local belief.

In some variations, the aggregate of the second local belief and the third local belief may include an average of the second local belief and the third local belief.

In some variations, the second local belief of the second node may be further updated based at least on a third local belief of a third node in the network.

In some variations, a statistical inference of the parameter set of the global machine learning model may be performed based at least on a parameter set of the first local machine learning model trained based on the first training data. The first local belief of the parameter set of the global machine learning model may be updated based at least on the statistical inference.

In some variations, the statistical inference may be a Bayesian inference.

In some variations, the global machine learning model may be a neural network. The parameter set may include one or more weights applied by the neural network.

In some variations, the global machine learning model may be a regression model. The parameter set may include a relationship between one or more independent variables and dependent variables.

In some variations, the network may include a plurality of nodes interconnected to form a strongly connected aperiodic graph.

In another aspect, there is provided a method for peer-to-peer training of a machine learning model. The method may include: training, based at least on a first training data available at a first node in a network, a first local machine learning model; updating, based at least on the training of the first local machine learning model, a first local belief of a parameter set of a global machine learning model; receiving, from a second node in the network, a second local belief of the parameter set of the global machine learning model, the second local belief having been updated based at least on the second node training a second local machine learning model, and the second local machine learning model being trained based at least on a second training data available at the second node; and updating, based at least on the second local belief of the second node, the first local belief of the parameter set of the global machine learning model.

In some variations, one or more features disclosed herein including the following features can optionally be included in any feasible combination. The method may further include: sending, to the second node, the first local belief of the parameter set of the global machine learning model such that the second local belief of the second node is further updated based on the first local belief of the first node.

In some variations, the method may further include: receiving, from a third node in the network, a third local belief of the parameter set of the global machine learning model, the third local belief having been updated based at least on the third node training a third local machine learning model, and the third local machine learning model being trained based at least on a third training data available at the third node; and updating, based at least on an aggregate of the second local belief and the third local belief, the first local belief of the parameter set of the global machine learning model.

In some variations, the aggregate of the second local belief and the third local belief may include an average of the second local belief and the third local belief.

In some variations, the second local belief of the second node may be further updated based at least on a third local belief of a third node in the network.

In some variations, the method may further include: performing, based at least on a parameter set of the first local machine learning model trained based on the first training data, a statistical inference of the parameter set of the global machine learning model; and updating, based at least on the statistical inference, the first local belief of the parameter set of the global machine learning model.

In some variations, the statistical inference may be a Bayesian inference.

In some variations, the global machine learning model may be a neural network. The parameter set may include one or more weights applied by the neural network.

In some variations, the global machine learning model may be a regression model. The parameter set may include a relationship between one or more independent variables and dependent variables.

In another aspect, there is provided a computer program product that includes a non-transitory computer readable medium storing instructions. The instructions may cause operations when executed by at least one data processor. The operations may include: training, based at least on a first training data available at a first node in a network, a first local machine learning model; updating, based at least on the training of the first local machine learning model, a first local belief of a parameter set of a global machine learning model; receiving, from a second node in the network, a second local belief of the parameter set of the global machine learning model, the second local belief having been updated based at least on the second node training a second local machine learning model, and the second local machine learning model being trained based at least on a second training data available at the second node; and updating, based at least on the second local belief of the second node, the first local belief of the parameter set of the global machine learning model.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a decentralized machine learning system, in accordance with some example embodiments.

FIG. 2A depicts a graph illustrating a mean square error (MSE) associated with nodes trained without collaboration, in accordance with some example embodiments;

FIG. 2B depicts a graph illustrating a mean square error (MSE) associated with nodes trained with collaboration, in accordance with some example embodiments;

FIG. 3 depicts graphs illustrating an accuracy achieved for distributed trained when the local dataset at each node is non-independent and identically distributed and balanced, in accordance with some example embodiments;

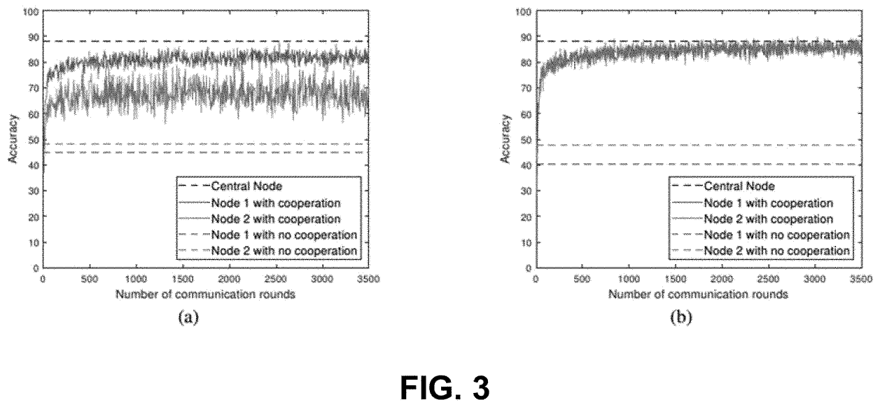

FIG. 4 depicts confusion matrices for distributed trained when the local dataset at each node is non-independent and identically distributed and balanced, in accordance with some example embodiments;

FIG. 5 depicts a graph illustrating an accuracy achieved for distributed trained when the local dataset at each node is non-independent and identically distributed and unbalanced, in accordance with some example embodiments;

FIG. 6 depicts a flowchart illustrating an example of a process for training a machine learning model, in accordance with some example embodiments; and

FIG. 7 depicts a block diagram illustrating a computing system, in accordance with some example embodiments.

When practical, similar reference numbers denote similar structures, features, or elements.

### DETAILED DESCRIPTION

A machine learning model may be trained cooperatively over a network of nodes including, for example, smartphones, personal computers, tablet computers, wearable apparatus, Internet-of-Things (IoT) appliances, and/or the like. The cooperative training of the machine learning model may include each node in the network training a local machine learning model using the local training data available at each node. In a centralized framework, each node in the network may be connected to a central server configured to maintain a global machine learning model. For example, the central server may select some of the nodes in the network, share the current global machine learning model with the selected nodes, and update the global machine learning model based on an average of the updates performed at the each of the selected nodes using local training data. However, the communication between the nodes and the central server may incur significant costs. Accordingly, in some example embodiments, a decentralized framework may be implemented to train a machine learning model cooperatively over a network of nodes.

In some example embodiments, instead of a central server communicating with a network of nodes to maintain a global machine learning model, each node in the network may train a local machine learning model using the local training data available at each node and communicate the corresponding updates to one or more other nodes in the network. In doing so, the nodes in the network may collaborate to train a global machine learning model including by learning a parameter space of the global machine learning model. For example, a first node in the network may perform, based on a first local training data available at the first node, a statistical inference (e.g., a Bayesian inference and/or the like) of the parameter space of the global machine learning model. However, the first local training data available at the first node is insufficient for the first node to learn the optical parameter space of the global machine learning model. Accordingly, the first node may collaborate with at least a second node in the network to learn the optimal parameter space of the global machine learning model. For instance, in addition to the first node using the first local training data to update a first local belief of the parameter space, the first local belief of the first node may be further updated based on a second local belief of the parameter space that the second node determines using a second local training data available at the second node. Moreover, the first node may share, with the second node, the first local belief such that the second local belief at the second node may also be updated based on the first local belief of the first node.

In some example embodiments, the global machine learning model may be a neural network (e.g., a deep neural network (DNN) and/or the like). Accordingly, the network of nodes, for example, the first node and the second node, may collaborate to learn the weights applied by the neural network including by exchanging and aggregating local beliefs of the values of these weights. Alternatively and/or additionally, the global machine learning model may be a regression model (e.g., a linear regression model and/or the like), in which case the network of nodes may collaborate to learn the relationship between one or more dependent variables and independent variables. For instance, the first node and the second node may exchange and aggregate local beliefs of the parameters (e.g., slope, intercept, and/or the like) of the relationship between the dependent variables and the independent variables. To maximize privacy when learning the parameter space of the global machine learning model, the nodes in the network may share the local beliefs of each node but not the local training data used to establish the local beliefs.

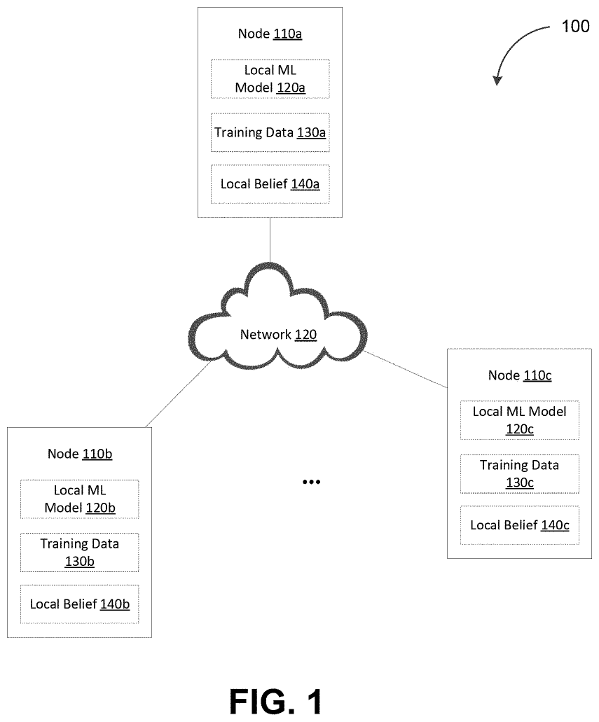

FIG. 1 depicts a system diagram illustrating an example of a decentralized machine learning system 100, in accordance with some example embodiments. Referring to FIG. 1, the decentralized learning system 100 may include a network of nodes that includes, for example, a first node 110a, a second node 110b, a third node 110c, and/or the like. Each of the first node 110a and the second node 110b may be a computing device such as, for example, a smartphone, a personal computer, a tablet computer, a wearable apparatus, and/or an Internet-of-Things (IoT) appliance. Moreover, as shown in FIG. 1, the first node 110a and the second node 110b may be communicatively coupled via a network 120. It should be appreciated that the network 120 may be a wired network and/or a wireless network including, for example, a local area network (LAN), a virtual local area network (VLAN), a wide area network (WAN), a public land mobile network (PLMN), the Internet, and/or the like.

In some example embodiments, the network of nodes may collaborate to train a global machine learning model such as, for example, a neural network, a regression model, and/or the like. As shown in FIG. 1, each node in the network may determine a local belief of a parameter space of the global machine learning model including, for example, the weights applied by the neural network, the relationship between the dependent variables and independent variables of the regression model, and/or the like. The local belief of a node in the network may be updated based on the training data available locally at that node as well as the local beliefs of one or more other nodes in the network.

For example, each node in the network may perform, based on the local training data available at the node, a statistical inference (e.g., a Bayesian inference and/or the like) of the parameter space of the global machine learning model and update the local belief of the node accordingly. Moreover, each node in the network may share, with one or more other nodes in the network, the local belief of the node. For instance, each node may further update its local belief of the parameter space of the global machine learning model based on an aggregate (e.g., an average and/or the like) of the local beliefs of the one or more other nodes in the network. In doing so, each node in the network may be able to determine the parameter space of the global machine learning model even when the training data that is available locally at each node is insufficient for learning the optical parameter space of the global machine learning model.

To further illustrate, in the example of the decentralized machine learning system 100 shown in FIG. 1, the first node 110a may train, based at least on a first training data 120a, a first local machine learning model 130a while the second node 110b may train, based at least on a second training data 120b, a second local machine learning model 130b and the third node 110c may train, based at least on a third training data 120c, a third local machine learning model 130c. In doing so, the first local 110a may update, based at least on the first training data 120a, a first local belief 140a of the parameter space of the global machine learning model. Furthermore, the second node 110b may update, based at least on the second training data 120b, a second local belief 140b of the parameter space of the global machine learning model while the third node 110c may update, based at least on the third training data 120c, a third local belief 140c of the parameter space of the global machine learning model.

In some example embodiments, the first node 110a, the second node 110b, and the third node 110c may collaborate in order to learn the parameter space of the global machine learning model. For example, the first training data 130a available at the first node 110a may be insufficient for the first node 110a to learn the parameter space of the global machine learning model. Accordingly, in order for the first node 110a to learn the parameter space of the global machine learning model, the first local belief 140a of the first node 110a may be further updated based at least on the local beliefs of one or more other nodes in the network. For instance, the first local belief 140a of the first node 110a may be further updated based on the local beliefs of the one-hop neighbors of the first node 110a.

As used herein, a “one-hop neighbor” of a node may refer to another node with which the node exchanges local beliefs although it should be appreciated that two nodes may constitute one-hop neighbors even if communication between the two nodes are exchanged via one or more intermediate nodes. Accordingly, if the second node 110b and the third node 110c are one-hop neighbors of the first node 110a, the first node 110a may receive the second local belief 140b of the second node 110b as well as the third local belief 140c of the third node 110c. The first node 110a may update, based at least on the second local belief 140b of the second node 110b and the third local belief 140c of the third node 110c, the first local belief 140a of the first node 110a. For example, the first local belief 140a of the first node 110a may be updated based on an aggregate (e.g., an average and/or the like) of the second local belief 140b of the second node 110b and the third local belief 140c of the third node 110c. Moreover, the first node 110a may also share, with the second node 110b and the third node 110c, the first local belief 140a of the first node 110a such that the second local belief 140b of the second node 110b and the third local belief 140c of the third node 110c may also be updated based on the first local belief 140a of the first node 110a.

To further illustrate, consider a group of N nodes that include, for example, the first node 110a, the second node 110b, and/or the like. Each node i∈[N] may have access to a dataset [symbol] ᵢ including n instance-label pairs, (Xᵢ^{(k)}, Yᵢ^{(k)}) wherein k∈[n]. Each instance Xᵢ^{(k)} ∈χᵢ⊆χ, wherein χᵢ may denote the local instance space (e.g., the local belief) of node i and χ may denote a global instance space (e.g., the parameter space) satisfying χ⊆∪ᵢ₌₁^{N}χᵢ. If [symbol] denotes the set of all possible labels over all of the N nodes, [symbol] = [symbol] may denote the set of all possible labels for a regression model while [symbol] ={0, 1} may denote the set of all possible label for a neural network configured to perform binary classification. The samples {X₁⁽¹⁾, Xᵢ⁽²⁾, . . . , Xᵢ⁽ⁿ⁾} may be independent and identically distributed, and generated according to a distribution Pᵢ∈ [symbol] (χᵢ). As such, each node i may perform, based on the locally available dataset [symbol] ᵢ, an inference (e.g., a Bayesian inference and/or the like) of the global instance space χ by generating a local instance space χᵢ having a distribution ƒᵢ((y|x)), ∀y∈ [symbol] , ∀x∈χ.

Consider a finite parameter set Θ with M points. If each node i has access to a set of local likelihood functions of labels {lᵢ(y; θ,x): y∈ [symbol] , θ∈Θ, x∈χᵢ}, wherein lᵢ(y; θ, x) may denote the local likelihood function of label y, given θ as the true parameter and the instance x being observed at the node i. For each node i, define

$${\overline{Θ}}_{i} := arg {min}_{θ ∈ Θ} {𝔼}_{{P}_{i}} [ {D}_{K L} ( {f}_{i} ( \cdot \vert {X}_{i} ) \vert \vert {l}_{i} ( \cdot \vert θ , {X}_{i} ) ) ] and {Θ}^{⋆} := {⋂}_{i = 1}^{N} {\overline{Θ}}_{i} .$$

Where Θ*≠ϕ, any parameter θ*∈Θ* may be globally learnable, for example, through collaboration between the group of N nodes. That is, there exists a parameter θ*∈Θ* that is globally learnable such that ∩ᵢ₌₁^{N}Θ̅ᵢ≠ϕ.

The communication network between group of N nodes (e.g., the network 120 between the first node 110a, the second node 110b, and/or the like) may be a directed graph with a vertex set [N]. The neighborhood of each node i, denoted by [symbol] (i), may be defined as the set of all nodes j who have an edge going from node j to node i. Furthermore, if node j∈ [symbol] (i), then node j may be able to exchange information with node i. The social interaction of the nodes may be characterized by a stochastic matrix W. The weight Wᵢⱼ∈[0,1] may be strictly positive if and only if j∈ [symbol] (i) and Wᵢⱼ=1−Σⱼ₌₁^{N}Wᵢⱼ. The weight Wᵢⱼ may denotes the confidence node i has on the information it receives from node j. In order for the information gathered at every node i to disseminate throughout the network, the nodes in the network may be interconnected to form a strongly connected aperiodic graph such that the matrix W is aperiodic as well as irreducible.

The criteria for learning a global learnable parameter θ*∈Θ* in a distributed manner across the network may include that for any confidence parameter δ∈(0, 1), P(∃i∈[N]s.t. \hat{θ}ᵢ⁽ⁿ⁾∉Θ*)≤δ, wherein \hat{θ}ᵢ⁽ⁿ⁾∉Θ may denote the estimate of node i after observing n instance-label pairs. Furthermore, the criteria may require each node i in the network to agree on a parameter that best fits the dataset distributed over the entire group of N nodes in the network.

In some example embodiments, each node i may exchange information with each other as well as merge information gathered from the other nodes. For example, at each instant k, each node i may maintain a private belief vector ρᵢ^{(k)}∈ [symbol] (Θ) as well as a public belief vector bᵢ^{(k)}∈ [symbol] (Θ). At each instant k∈[n], each node i may execute the Algorithm 1 set forth in Table 1 below.

TABLE 1
Algorithm 1. Peer-to-peer Federated Learning Algorithm

| | |
|---|---|
| 1: | Inputs: ρᵢ⁽⁰⁾ ∈ [symbol] (Θ) with ρᵢ⁽⁰⁾ > 0 for all i ∈ [N] |
| 2: | Outputs: \hat{θ}ᵢ⁽ⁿ⁾ for all i ∈ [N] |
| 3: | for instance k = 1 to n do |
| 4: | for node i = 1 to N do in parallel |
| 5: | Draw an i.i.d sample Xᵢ^{(k)} ~ Pᵢ and obtain |
| | a conditionally i.i.d sample label Yᵢ^{(k)} ~ |
| | fᵢ(·\|Xᵢ^{(k)})Pᵢ(Xᵢ^{(k)}). |
| 6: | Perform a local Bayesian update on ρᵢ^{(k-1)} to |
| | form the belief vector bᵢ^{(k)} using the following |
| | rule. For each θ ∈ Θ, |
| | ${b}_{i}^{( k )} ( θ ) = \frac{{l}_{i} ( {Y}_{i}^{( k )} ; θ , {X}_{i}^{( k )} ) {ρ}_{i}^{( k - 1 )} ( θ )}{{\sum }_{ψ ∈ Θ} {l}_{i} ( {Y}_{i}^{( k )} ; ψ , {X}_{i}^{( k )} ) {ρ}_{i}^{( k - 1 )} ( ψ )} \qquad ( 2 )$ |
| 7: | Send bᵢ^{(k)} to all nodes j for which i ∈ [symbol] (j). |
| | Receive bⱼ^{(k)} from neighbors j ∈ [symbol] (i). |
| 8: | Update private belief by averaging the log beliefs |
| | received from neighbors , i.e., for each θ ∈ Θ, |
| | ${ρ}_{i}^{( k )} ( θ ) = \frac{exp ( {\sum }_{j = 1}^{N} {W}_{ij} log {b}_{j}^{( k )} ( θ ) )}{{\sum }_{ψ ∈ Θ} exp ( {\sum }_{j = 1}^{N} {W}_{ij} log {b}_{j}^{( k )} ( ψ ) )} \qquad ( 3 )$ |
| 9: | Declare an estimate |
| | ${\hat{θ}}_{i}^{( k )} := {argmax}_{θ ∈ Θ} {ρ}_{i}^{( k )} ( θ ) .$ |
| 10: | end for |
| 11: | end for |

In some example embodiments, the group of N nodes may collaborate in order to train a regression model (e.g., a linear regression model and/or the like) including by learning the relationship between one or more dependent variables and independent variables. Allowing d≥2 and Θ= [symbol] ^{d+1}. For θ=[θ₀, θ₁, . . . , θ_{d}]^{T}∈Θ, x, ∈ [symbol] ^{d}, define ƒ_{θ}(x):=θ₀+Σᵢ₌₁^{d}θᵢxᵢ= [symbol] θ, [1, x^{T}]^{T} [symbol] . The label variable y∈ [symbol] may be given by a deterministic function ƒ_{θ}(x) with additive Gaussian noise η˜N(0, α²) such that [symbol] =ƒ_{θ}(x)+η.

In the network of N nodes, consider the realizable setting where there exists a θ*∈Θ which generates the labels [symbol] ∈ [symbol] as given by [symbol] =ƒ_{θ}(x)+η. Fix some 0<m<d, allow

$${X}_{1} = \{ [ \begin{matrix}x \\ 0\end{matrix} ] \vert x ∈ {ℝ}^{m} \} and {X}_{2} = \{ [ \begin{matrix}0 \\ x\end{matrix} ] \vert x ∈ {ℝ}^{d - m} \} ,$$

and assume that each node i is either a type-1 node making observations corresponding to points in χ₁ or a type-2 node making observations corresponding to points in χ₂. Given the deficiency of the local data at each node i, the N nodes may collaborate in order to disambiguate the set Θ̅₁={θ∈Θ|θ_{(0:m)}=θ*_{(0:m)}}. That is, each node i may execute Algorithm 1 in order to collaborate with other nodes to learn the true parameter θ*.

Consider a network of two nodes in which Node 1 is a type-1 node and Node 2 is a type-2 node with Θ= [symbol] ³ and χ= [symbol] ² (e.g., d=2, m=1) and θ*=[−0.3, 0.5, 0.8]^{T}. Let the edge weights be given by

$$W = [ \begin{matrix}0.9 & 0.1 \\ 0.6 & 0.4\end{matrix} ] .$$

suppose the observation noise is distributed as η˜ [symbol] (0, α²) where α=0.8. Training data D₁ of Node 1 may include instance-label pairs for [x₁, 0]^{T}∈ [symbol] ² where x₁ is sampled from Unif[−1, 1] and training data D₂ of Node 2 may include instance-label pairs for [0, x₂]^{T} where x₂ is sampled from Unif[−1.5, 1.5]. However, the test set may include observations belonging to x∈R². Each node may be assumed to start with a Gaussian prior over θ with zero mean [0, 0, 0]^{T} and covariance matrix given by diag[0.5, 0.5, 0.5].

Node 1 and Node 2 may collaborate to learn the posterior distribution on θ using, for example, Algorithm 1 shown in Table 1. Since Node 1 and Node 2 begin with a Gaussian prior on θ, the local beliefs at Node 1 and Node 2 may remain Gaussian subsequent to the Bayesian. Furthermore, if bᵢ^{(k)}˜ [symbol] (μᵢ, Σᵢ) wherein i∈{0,1}, then Equation (3) from Algorithm 1 may reduce to \tilde{Σ}ᵢ⁻¹=Wᵢ₁⁻¹+Wᵢ₂Σ₂⁻¹ and \tilde{μ}ᵢ=\tilde{Σ}ᵢ(Wᵢ₁Σ₁⁻¹μ₁+Wᵢ₂Σ₂⁻¹μ₂) in which ρᵢ^{(k)}˜ [symbol] (\tilde{μ}ᵢ,\tilde{Σ}ᵢ) where i∈{1, 2}. The local beliefs of Node 1 and Node 2 remaining Gaussian subsequent to the sharing and aggregating of the local beliefs may imply that the corresponding predictive distribution also remains Gaussian.

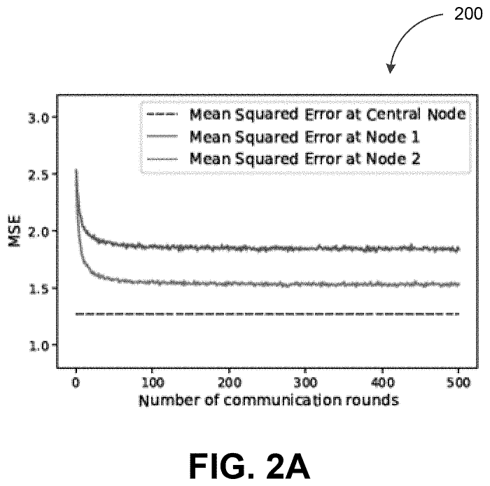

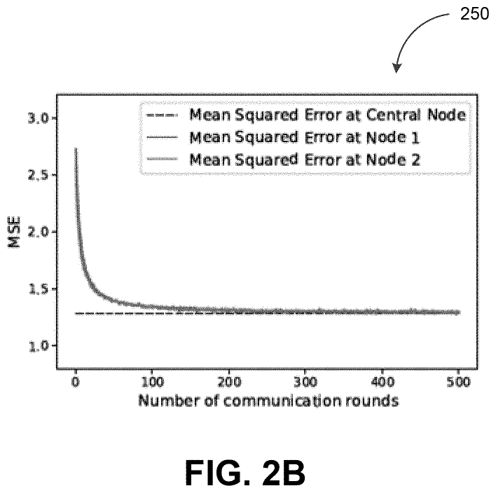

The mean squared error (MSE) of the predictions over the test set, when Node 1 and Node 2 are trained using Algorithm 1, may be compared with the mean squared error of two cases: (1) a central node which has access to training data samples x=[x₁,x₂]^{T}∈ [symbol] where x₁ is sampled from Unif[−1, 1] and x₂ is sampled from Unif[−1.5, 1.5], and (2) nodes learn without without cooperation using local training data only. FIG. 2A depicts a graph 200 illustrating the mean square error associated with Node 1 and Node 2 learning the parameters of a regression model based on locally available training data alone and without any collaboration between Node 1 and Node 2. As shown in FIG. 2A, when trained without cooperation, the mean squared errors of Node 1 and Node 2 are higher than that of the central node implying a degradation in the performance of Node 1 and Node 2 due to a lack of sufficient information to learn the true parameter θ*. FIG. 2B depicts a graph 250 illustrating the mean square error associated with Node 1 and Node 2 collaborating to learn the parameters of the regression model. As shown in FIG. 2B, the main squared errors of Node 1 and Node 2, when trained collaboratively, matches that of a central node implying that Node 1 and Node 2 are able to learn the true parameter θ*.

In some example embodiments, the group of N nodes may also collaborate in order to train a neural network (e.g., a deep neural network and/or the like) including by learning the weights applied by the neural network. Algorithm 1, as set forth in Table 1 above, may be modified for training a neural network including, for example, by modifying the statistic inference (e.g., Bayesian inference and/or the like) and the aggregation performed at each node i.

In some example embodiments, each node i may perform a statistical inference (e.g., Bayesian inference and/or the like) to learn an approximate posterior distribution of the parameter space of the global machine learning model. For example, q_{φ}∈ [symbol] (Θ) may denote an approximating variational distribution, parameterized by φ, which may be easy to evaluate such as the exponential family. The statistical inference that is performed as part of Algorithm 1 may be modified to determine an approximating distribution that is as close as possible to the posterior distribution obtained using Equation (2) from Algorithm 1. In other words, given a prior ρᵢ^{(k)}(η) for all θ∈Θ and the likelihood functions {lᵢ(y; θ, x): [symbol] ∈ [symbol] ,θ∈Θ, x∈χᵢ}, the statistical inference may be performed to learn an approximate posterior qφ(⋅) over Θ at each node i. This may involve maximizing the evidence lower bound (ELBO) with respect to the variational parameters defining φ, [symbol] _{V1}(φ)):=−∫_{Θ}(θ)log lᵢ(y; θ, x)dθ+D_{KL}(q_{φ}(θ)∥ρᵢ^{(k)}((θ)). Furthermore, instead of performing updates subsequent to every observed training sample, a batch of observations may be used for obtaining the approximate posterior update by applying one or more variational inference techniques.

As part of Algorithm 1, each node i may also aggregate the local beliefs of one or more other nodes but this operation may be computationally intractable due to the need for normalization. Accordingly, in some example embodiments, when each node i updates its local belief based on an aggregate of the unnormalized local beliefs of the other nodes in the network. An unnormalized belief vector ρᵢ^{(k)} may be used without altering the optimization problem expressed as D_{KL}(q_{φ}(θ)∥κρᵢ^{(k)}(θ))=D_{KL}(q_{φ}(θ)∥ρᵢ^{(k)}(θ))−log κ wherein κ>0.

The performance of a collaboratively trained neural network may be evaluated based on the Modified National Institute of Standards and Technology (MNIST) fashion dataset, which includes 60,000 training pixel images and 10,000 testing pixel images. The group of N nodes may collaborate to train, based on the MNIST fashion dataset, a fully connected neural network, with one hidden layer having 400 units. Each image in the MNIST fashion dataset may be labelled with its corresponding number (between zero and nine, inclusive). Let [symbol] ᵢ for i∈{1, 2} denote the local training dataset at each node i. The local neural network at each node i may be trained to learn a distribution over its weights θ (e.g., the posterior distribution P(θ| [symbol] ᵢ) at each node i).

The nodes may be trained without cooperation to learn a Gaussian variational approximation to P(θ| [symbol] ᵢ) by applying one or more variational inference techniques, in which case the approximating family of distributions may be Gaussian distributions belonging to the class {q(⋅; μ, Σ): μ∈ [symbol] ^{d}, Σ=diag(σ), σ∈ [symbol] ^{d}} wherein d may denote the number of weights in the neural network. A Bayes by backprop training algorithm may be applied to learn the Gaussian variational posterior. Weights from the variational posterior may subsequently be sampled to make predictions on the test set. Moreover, the nodes may be embedded in an aperiodic network with edge weights given by W. Contrastingly, training the nodes cooperatively may include each node i applying Algorithm 1 but performing a variational inference instead of a Bayesian inference to update its local beliefs of the parameters of the neural network. Bayes by backprop training algorithm may also be applied to learn the Gaussian variational posterior at each node i. Furthermore, since the approximating distributions for bᵢ^{k} are Gaussian distributions, the aggregation of local beliefs may reduce to \tilde{Σ}ᵢ⁻¹=Wᵢ₁Σ₁⁻¹+Wᵢ₂Σ₂⁻¹ and \tilde{μ}ᵢ=\tilde{Σ}ᵢ(Wᵢ₁Σ₁⁻¹μ₁+Wᵢ₂Σ₂⁻¹μ₂) such that ρᵢ^{(k)}˜ [symbol] (\tilde{μ}ᵢ,\tilde{Σ}ᵢ) where i∈{1, 2}.

A central node with access to all of the training samples may achieve an accuracy of 88.28%. The MNIST training set may be divided in an independent and identically distributed manner in which each local training dataset [symbol] ᵢ includes half of the training set samples. In this setting, the accuracy at Node 1 may be 87.07% without cooperation and 87.43% with cooperation while the accuracy at Node 2 may be 87.43% without cooperation and 87.84% with cooperation. These outcome indicate that there may be no loss in accuracy due to cooperation.

The performance of Node 1 and Node 2 may be further evaluated in two additional settings. In a first non-independent and identically distributed and balanced setting, data at each node i may be obtained using different labelling distributions including, for example, a first case in which the local dataset [symbol] ₁ at Node 1 includes training samples with labels only in the classes {0, 1, 2, 3, 4} and the local data set [symbol] ₂ at Node 2 includes training samples with labels only in the classes {5, 6, 7, 8, 9}, and a second case in which the local dataset [symbol] ₁ at Node 1 includes training samples with labels only in the classes {0, 2, 3, 4, 6} and the local dataset [symbol] ₂ at Node 2 includes training samples with labels only in the classes {1, 5, 7, 8, 9}. A weight matrix

$$W = [ \begin{matrix}0.25 & 0.75 \\ 0.75 & 0.25\end{matrix} ]$$

may be applied when Node 1 and Node 2 cooperate.

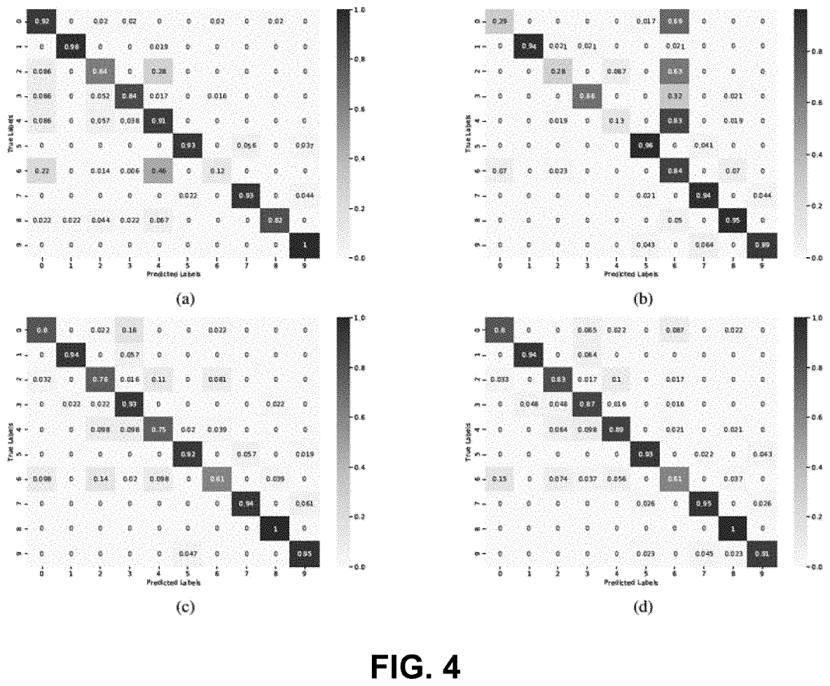

In the first case, when Node 1 and Node 2 are trained without cooperation, Node 1 and Node 2 may obtain an accuracy of 44.89% and 48.22% respectively. Notably, as shown in FIG. 4(a), the performance of Node 1 and Node 2 may improve to 83% and 67% respectively when Node 1 and Node 2 are trained collaboratively, for example, by applying Algorithm 1. The label set {0, 2, 3, 4, 6}, which corresponds to t-shirt (0), pullover (2), dress (3), coat (4), and shirt (6), may be associated with similar looking images compared to the images associated with other labels. As shown in FIG. 4(a), since node 1 has access to training samples for the classes {0, 2, 3, 4} except class 6, Node 1 may misclassify class 6 as {0, 2, 3, 4} whereas other classes including those inaccessible to Node 1 may be classified correctly with high accuracy. Similarly, as shown in FIG. 4(b), since Node 2 has access to training samples for the class 6 but not for classes {0, 2, 3, 4}, these classes may be frequently misclassified as class 6. This may explain the poor accuracy obtained at Node 2 compared to the accuracy obtained at Node 1.

In the second case, Node 1 and Node 2 may achieve an accuracy of 40.4% and 47.8% respectively when trained without cooperation whereas Node 1 and Node 2 may achieve an accuracy of 85.78% and 85.86% respectively when trained collaboratively. Referring to FIG. 4(c), since Node 1 has access to training samples for the classes {0, 2, 3, 4, 6}, Node 1 may be able to obtain a high accuracy in those classes. Meanwhile, FIG. 4(d) shows that since Node 2 is learning from the Node 1, Node 2 may no longer misclassify the classes {0, 2, 3, 4, 6}. Hence, in this setup, Node 1 and Node 2 are both able to achieve a high accuracy. Accordingly, a setup in which each node is an expert at its local task distributed training may in turn enable every other node in the network to also become an expert on the network-wide task.

Alternatively, in a second non-independent and identically distributed and unbalanced setting, the quantity of training samples at each node may be highly unbalanced. The cases being considered include a first case in which the local dataset [symbol] ₁ at Node 1 includes training samples with labels only in the classes {0, 1, 2, 3, 4, 5, 6, 7} and the local dataset [symbol] ₂ at Node 2 includes training samples with labels only in the classes {8, 9}. A weight matrix

$$W = [ \begin{matrix}0.45 & 0.55 \\ 0.70 & 0.30\end{matrix} ]$$

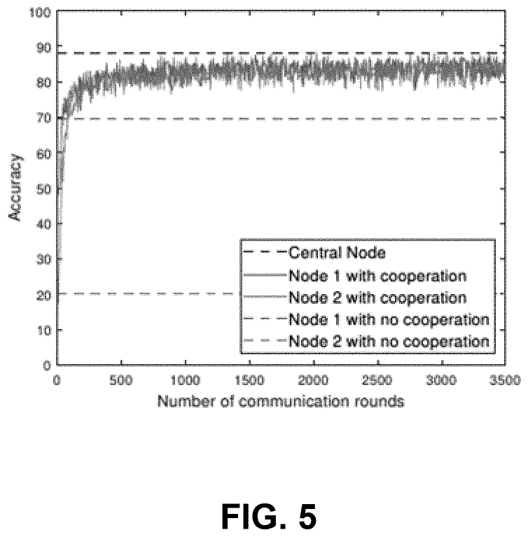

may be applied when Node 1 and Node 2 cooperate. In this setting, when Node 1 and Node 2 are trained without cooperation, Node 1 and Node 2 may achieve an accuracy of 69.44% and 19.95% respectively. Contrastingly, when trained collaboratively, Node 1 and Node 2 may be able to achieve an accuracy of 85.8% and 85.2% respectively. FIG. 5 shows that the presence of a single export at a network-wide task may improve the accuracy of the other nodes in the network.

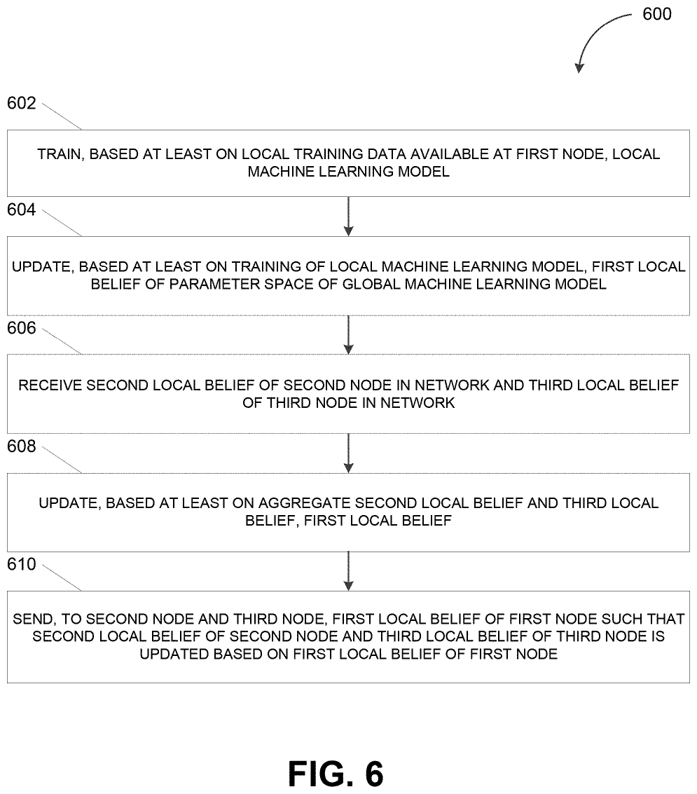

FIG. 6 depicts a flowchart illustrating an example of a process 600 for training a machine learning model, in accordance with some example embodiments. Referring to FIGS. 1 and 6, the process 600 may be performed at each node in a network in order for the nodes to collaboratively train a machine learning model such as, for example, a neural network (e.g., a deep neural network), a regression model (e.g., a linear regression model), and/or the like. For example, as shown in FIG. 1, the first node 110a, the second node 110b, and the third node 110c may each perform the process 600 in order to collaboratively train a machine learning model including by learning a parameter space of the machine learning model.

At 602, a first node in a network may train, based at least on a local training data available at the first node, a local machine learning model. For example, the first node 110a may train, based at least on the first training data 130a available at the first node 110a, the first local machine learning model 120a.

At 604, the first node may update, based at least on the training of the first local machine learning model, a first local belief of a parameter space of a global machine learning model. In some example embodiments, the first node 110a may update the first local belief 140a of the parameter space of the global parameter space by at least performing, based at least on the first training data 130a available at the first node 110a, a statistical inference (e.g., a Bayesian inference and/or the like). For example, the first node 110a may perform a statistical inference to update, based at least on the parameters of the first local machine learning model 120a trained based on the first training data 130a, the first local belief 140a of the parameter space of the global parameter space.

At 606, the first node may receive a second local belief of a second node in the network and a third local belief of a third node in the network. In some example embodiments, the first node 110a may collaborate with other nodes in the network, for example, the second node 110b and the third node 110c, in order to learn the parameter space of the global machine learning model. The first node 110a may collaborate with other nodes in the network at least because the first training data 120a available at the first node 110a is insufficient for learning the parameter space of the global machine learning model. Accordingly, the first node 110a may exchange local beliefs with one or more nodes that are one-hop neighbors of the first node 110a. Privacy may be maximized during the collaborative learning of the parameter space of the global machine learning model because the nodes in the network may share the local beliefs of each node but not the local training data used to establish the local beliefs.

For instance, in the example shown in FIG. 1, the first node 110a may receive, from the second node 110b, the second local belief 140b of the second node 110b, which may be updated based at least on the second training data 120b available at the second node 110b. Alternatively and/or additionally, the first node 110a may also receive, from the third node 110c, the third local belief 140c of the third node 110c. which may be updated based at least on the third training data 120c available at the third node 110c.

At 608, the first node may update, based at least on an aggregate of the second local belief of the second node and the third local belief of the third node, the first local belief of the first node. For example, the first local belief 140a of the first node 110a may be updated based on an aggregate (e.g., an average and/or the like) of the second local belief 140b of the second node 110b and/or the third local belief 140c of the third node 110c.

At 610, the first node may send, to the second node and the third node, the first local belief of the first node. In some example embodiments, in addition to aggregating the second local belief 140b of the second node 110b and the third local belief 140c of the third node 110c, the first node 110a may also share the first local belief 140a with the second node 110b and the third node 110c. In doing so, the first node 110a may enable the second node 110b to update, based at least on the first local belief 140a of the first node 110a, the second local belief 140b of the second node 110b. Furthermore, the first node 110a sharing the first local belief 140b with the third node 110c may enable the third local belief 140c of the third node 110c to be updated based on the first local belief 140a of the first node 110a. The sharing of local beliefs may, as noted, disseminate information throughout the network without compromising the privacy and security of the local training data available at each node.

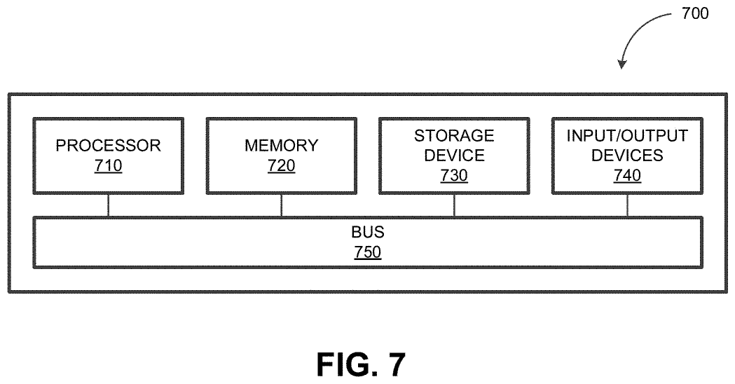

FIG. 7 depicts a block diagram illustrating a computing system 700, in accordance with some example embodiments. Referring to FIGS. 1 and 7, the computing system 700 can be used to implement a network node (e.g., the first node 110a, the second node 110b, the third node 110c, and/or the like) and/or any components therein.

As shown in FIG. 7, the computing system 700 can include a processor 710, a memory 720, a storage device 730, and input/output devices 740. The processor 710, the memory 720, the storage device 730, and the input/output devices 740 can be interconnected via a system bus 750. The processor 710 is capable of processing instructions for execution within the computing system 700. Such executed instructions can implement one or more components of, for example, the first node 110a, the second node 110b, the third node 110c, and/or the like. In some implementations of the current subject matter, the processor 710 can be a single-threaded processor. Alternately, the processor 710 can be a multi-threaded processor. The processor 710 is capable of processing instructions stored in the memory 720 and/or on the storage device 730 to display graphical information for a user interface provided via the input/output device 740.

The memory 720 is a computer readable medium such as volatile or non-volatile that stores information within the computing system 700. The memory 720 can store data structures representing configuration object databases, for example. The storage device 730 is capable of providing persistent storage for the computing system 700. The storage device 730 can be a floppy disk device, a hard disk device, an optical disk device, or a tape device, or other suitable persistent storage means. The input/output device 740 provides input/output operations for the computing system 700. In some implementations of the current subject matter, the input/output device 740 includes a keyboard and/or pointing device. In various implementations, the input/output device 740 includes a display unit for displaying graphical user interfaces.

According to some implementations of the current subject matter, the input/output device 740 can provide input/output operations for a network device. For example, the input/output device 740 can include Ethernet ports or other networking ports to communicate with one or more wired and/or wireless networks (e.g., a local area network (LAN), a wide area network (WAN), the Internet).

In some implementations of the current subject matter, the computing system 700 can be used to execute various interactive computer software applications that can be used for organization, analysis and/or storage of data in various (e.g., tabular) format (e.g., Microsoft Excel®, and/or any other type of software). Alternatively, the computing system 700 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 740. The user interface can be generated and presented to a user by the computing system 700 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor provides operations comprising:
training, based at least on a first training data available at a first node in a network, a first local machine learning model;
updating, based at least on the training of the first local machine learning model, a first local belief of a parameter set of a global machine learning model;
receiving, from a second node in the network, a second local belief of the parameter set of the global machine learning model, the second local belief having been updated based at least on the second node training a second local machine learning model, and the second local machine learning model being trained based at least on a second training data available at the second node; and
updating, based at least on the second local belief of the second node, the first local belief of the parameter set of the global machine learning model.

2. The system of claim 1, further comprising:
sending, to the second node, the first local belief of the parameter set of the global machine learning model such that the second local belief of the second node is further updated based on the first local belief of the first node.

3. The system of claim 1, further comprising:
receiving, from a third node in the network, a third local belief of the parameter set of the global machine learning model, the third local belief having been updated based at least on the third node training a third local machine learning model, and the third local machine learning model being trained based at least on a third training data available at the third node; and
updating, based at least on an aggregate of the second local belief and the third local belief, the first local belief of the parameter set of the global machine learning model.

4. The system of claim 3, wherein the aggregate of the second local belief and the third local belief comprises an average of the second local belief and the third local belief.

5. The system of claim 1, wherein the second local belief of the second node is further updated based at least on a third local belief of a third node in the network.

6. The system of claim 1, further comprising:
performing, based at least on a parameter set of the first local machine learning model trained based on the first training data, a statistical inference of the parameter set of the global machine learning model; and
updating, based at least on the statistical inference, the first local belief of the parameter set of the global machine learning model.

7. The system of claim 6, wherein the statistical inference comprises a Bayesian inference.

8. The system of claim 1, wherein the global machine learning model comprises a neural network, and wherein the parameter set includes one or more weights applied by the neural network.

9. The system of claim 1, wherein the global machine learning model comprises a regression model, and wherein the parameter set includes a relationship between one or more independent variables and dependent variables.

10. The system of claim 1, wherein the network includes a plurality of nodes interconnected to form a strongly connected aperiodic graph.

11. A computer-implemented method, comprising:
training, based at least on a first training data available at a first node in a network, a first local machine learning model;
updating, based at least on the training of the first local machine learning model, a first local belief of a parameter set of a global machine learning model;
receiving, from a second node in the network, a second local belief of the parameter set of the global machine learning model, the second local belief having been updated based at least on the second node training a second local machine learning model, and the second local machine learning model being trained based at least on a second training data available at the second node; and
updating, based at least on the second local belief of the second node, the first local belief of the parameter set of the global machine learning model.

12. The method of claim 11, further comprising:
sending, to the second node, the first local belief of the parameter set of the global machine learning model such that the second local belief of the second node is further updated based on the first local belief of the first node.

13. The method of claim 11, further comprising:
receiving, from a third node in the network, a third local belief of the parameter set of the global machine learning model, the third local belief having been updated based at least on the third node training a third local machine learning model, and the third local machine learning model being trained based at least on a third training data available at the third node; and
updating, based at least on an aggregate of the second local belief and the third local belief, the first local belief of the parameter set of the global machine learning model.

14. The method of claim 13, wherein the aggregate of the second local belief and the third local belief comprises an average of the second local belief and the third local belief.

15. The method of claim 11, wherein the second local belief of the second node is further updated based at least on a third local belief of a third node in the network.

16. The method of claim 11, further comprising:
performing, based at least on a parameter set of the first local machine learning model trained based on the first training data, a statistical inference of the parameter set of the global machine learning model; and
updating, based at least on the statistical inference, the first local belief of the parameter set of the global machine learning model.

17. The method of claim 16, wherein the statistical inference comprises a Bayesian inference.

18. The method of claim 11, wherein the global machine learning model comprises a neural network, and wherein the parameter set includes one or more weights applied by the neural network.

19. The method of claim 11, wherein the global machine learning model comprises a regression model, and wherein the parameter set includes a relationship between one or more independent variables and dependent variables.

20. A non-transitory computer readable medium storing instructions, which when executed by at least one data processor, result in operations comprising:
training, based at least on a first training data available at a first node in a network, a first local machine learning model;
updating, based at least on the training of the first local machine learning model, a first local belief of a parameter set of a global machine learning model;
receiving, from a second node in the network, a second local belief of the parameter set of the global machine learning model, the second local belief having been updated based at least on the second node training a second local machine learning model, and the second local machine learning model being trained based at least on a second training data available at the second node; and
updating, based at least on the second local belief of the second node, the first local belief of the parameter set of the global machine learning model.
